(19) United States
(12) Patent Application Publication
(10) Pub. No.: US 2007/0146933 A1
(43) Pub. Date: Jun. 28, 2007

(54) MAGNETIC HEAD DEVICE

(75) Inventor: Tsuyoshi Matsumoto, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/613,928

(22) Filed: Dec. 20, 2006

(30) Foreign Application Priority Data
Dec. 28, 2005 (JP) 2005-376868

(51) Int. Cl. G11B 5/60

(52) U.S. Cl. 360/234.3

(57) ABSTRACT

A magnetic head device is provided. The magnetic head device includes a slider that has a facing side which faces a recording medium, and a pressing side on which a pressing force to a recording medium acts. A magnetic device is provided on the trailing side of the slider. The facing side of the slider is provided with a front positive pressure surface located on the leading side of the slider and a rear positive pressure surface located on the trailing side of the slider. The magnetic device is provided in the vicinity behind the rear positive pressure surface. Air guide grooves are respectively formed on both sides of the rear positive pressure surface, and a part of the rear positive pressure surface exists further behind than the air guide grooves.

This application claims the benefit of Japanese Patent Application No. 2005-376868 filed Dec. 28, 2005, which is hereby incorporated by reference.

### TECHNICAL FIELD

The present embodiments relate to a magnetic head device causing a stable floating force to act on the trailing side at all times.

### BACKGROUND

A magnetic head device records magnetic signals on a magnetic recording medium, such as a hard disk, and reads magnetic signals recorded on the magnetic recording medium. Conventionally, a magnetic head device has a slider facing the magnetic recording medium and has a magnetic functional part provided at a trailing end of the slider. The magnetic functional part has a reproducing functional part using an MR effect or a GMR effect, and a recording functional part in which a yoke, a coil, or the like, which is made of a magnetic material, is formed as a thin film.

Although the slider of the magnetic head device is pressed on the surface of the magnetic recording medium by an elastic member called a load beam, or the like the slider will float from the recording medium when the magnetic recording medium rotates. A predetermined floating height is set between the magnetic functional part and the recording medium by the airflow (air bearing), which flows into a space between the surface and the slider.

In the current magnetic head device, in order to cope with an improvement in the magnetic recording density to a magnetic recording medium and to attain high-speed recording speed and high-speed reproducing of magnetic signals, it is necessary to stabilize the floating posture of the slider, and to set the floating height of the magnetic functional part from the recording medium as low as possible. A positive pressure surface, which generates a floating force, is formed on the facing side of the slider so as to be divided into positive pressure surfaces on the leading side and the trailing side.

The inclined posture of the slider in a floating state can be stabilized by a floating force which acts on a front positive pressure surface, and the area of a rear positive pressure surface is set to be smaller than the area of the front positive pressure surface, so that the floating distance between the magnetic functional part provided in the vicinity of the rear positive pressure surface and recording medium can be reduced.

In a magnetic head device described in PCT Japanese Translation Patent Publication No. 2003-515869 (U.S. Pat. No. 650,468), an air guide groove, which is depressed toward a trailing end face, is formed in the rear positive pressure surface, the airflow when a recording medium rotates is guided rearward from the air guide groove, and the airflow is locally centralized on the rear positive pressure surface so as to generate local positive pressure. A local positive pressure surface is formed in the rear positive pressure surface to stabilize the floating force which acts on the rear positive pressure surface, and consequently, to stabilize the floating distance of a trailing end of a slider from the recording medium.

PCT Japanese Translation Patent Publication No. 2003-515869 also discloses an aspect in which an air guide groove is formed so as to be divided into grooves located on both the right and left sides of the centerline.

In the magnetic head device described in PCT Japanese Translation Patent Publication No. 2003-515869, the air guide groove provided in a rear positive pressure surface is formed parallel to the centerline. Therefore, if the airflow formed on the surface of the recording medium is flowing parallel to the centerline, air can be collected by the air guide groove and partially centralized on the rear positive pressure surface located behind the air guide groove.

Generally, in a magnetic head device to be used for a disc-like recording medium, such as a hard disk, a slider is attached to a tip of an arm, the arm rotates about its base, and the slider moves between an inner peripheral end point (ID) of a recording medium, and an outer peripheral end point (OD) of the recording medium. Although the slider temporarily takes a posture in which the centerline of the slider is parallel to the recording-medium (MD), a predetermined tilt angle exists between the centerline of the slider and the direction of airflow in other states.

If the tilt angle exists, the airflow which flows obliquely with respect to the centerline cannot be efficiently collected by the air guide groove, but a local positive pressure generating part becomes hard to form in a rear positive pressure surface, and a positive pressure generating region is apt to be decentralized over a broad range of a rear positive pressure surface. As a result, the floating force which acts on the rear positive pressure surface changes depending on the change of the tilt angle, and the floating distance of the magnetic functional part, which is provided at the trailing end of the slider, from the recording medium is apt to change.

Recently, in order to cause a magnetic part to further approach a recording medium when a slider takes a floating posture, a heater which heats the magnetic functional part and its neighborhood is provided in the slider, and the portion of the slider where the magnetic functional part is provided is caused to protrude towards the recording medium by the heat of the heater. In a magnetic head having such a configuration, if a positive pressure generating region is distributed over a broad range of the rear positive pressure surface, a floating force will act on the portion caused to protrude towards the recording medium. As a result, the portion caused to project towards the recording medium so as to cause the magnetic functional part to approach the recording medium tends to be separated from the recording medium by this floating force, and thus the effect of providing the heater to cause the portion to protrude will be offset.

### SUMMARY

The present embodiments may obviate one or more of the limitations or drawbacks of the related art. For example, in one embodiment, a magnetic head device in which a local positive pressure generating part is formed in a rear positive pressure surface, and a region which causes positive pressure to act locally does becomes less likely to change depending on the tilt angle of a slider, and consequently a stable floating force can always be caused to act on the rear positive pressure surface.

In one embodiment, a magnetic head device includes a slider that has a facing side which faces a recording medium, and a pressing side on which a pressing force to a recording medium acts, and a magnetic functional part provided on the trailing side of a slider to exhibit at least one function of magnetic recording and magnetic reproducing.

The facing side of the slider is provided with a front positive pressure surface located on the leading side of the slider and a rear positive pressure surface located on the trailing side of the slider, and the magnetic functional part is provided in the vicinity behind the rear positive pressure surface or within the rear positive pressure surface.

Air guide grooves are respectively formed on both sides of the rear positive pressure surface with respect to a reference line that is a virtual straight line which extends from the leading side to the trailing side through the center of the magnetic functional part. A part of the rear positive pressure surface exists further behind than the air guide grooves. Each of the air guide grooves inclines linearly or curvedly such that an inside inner wall thereof on the side of the reference line is gradually away from the reference line as it goes to the trailing side.

In one embodiment, airflow can be converged by the air guide grooves formed in the rear positive pressure surface, and a positive pressure part can be locally formed in the rear positive pressure surface located behind the air guide groove. Moreover, since the inside inner wall of the air guide groove inclines, even if a tilt angle is formed by movement of the slider and the tilt angle changes, the function that airflow is converged by the air guide grooves can always be exhibited, and the local positive pressure part in the rear positive pressure surface can always be stabilized. The floating distance of the trailing end face of the slider can be stabilized without being influenced by the tilt angle.

In one embodiment, an outside inner wall which faces the inside inner wall of each air guide groove inclines in the same direction as the inside inner wall

Alternatively, in another embodiment, an outside inner wall, which faces the inside inner wall of each air guide groove, extends parallel to the reference line.

Furthermore, the outside inner wall may incline so as to be gradually away from the reference line as it goes to the trailing side.

If the outside inner wall is parallel to the reference line, or inclines such that it may be gradually away from the reference line as it goes to the leading side, even if an opening of an air guide groove is enlarged towards the leading side and consequently the tilt angle changes, air can always be caught by the air guide groove, and it becomes easy to form a stable local positive pressure part.

In this embodiment, an internal angle between the reference line and the inside inner wall is greater than a maximum value of a tilt angle when the slider moves on the recording medium.

By setting the angles as mentioned above, even when the tilt angle becomes the greatest, it becomes easy to catch the airflow by the air guide groove, and it becomes easy to stably form a local positive pressure part in the rear positive pressure surface.

In one embodiment, the rear positive pressure surface is formed such that its central portion located on the reference line protrudes or is allowed to protrude nearer to the recording medium than its side parts located further behind than a rear end of the air guide groove. For example, the slider is provided with a heater which heats the magnetic functional part, and the central portion is allowed to protrude by the heat of the heater.

In a configuration in which the magnetic functional part protrudes towards the recording medium as described above, when the slider takes a floating posture, the distance between the magnetic functional part and the recording medium can be shortened. A large positive pressure hardly acts on the portion projecting towards the recording medium by forming local positive pressure parts on both sides of the rear positive pressure surface with respect to the reference line. Therefore, the distance between the magnetic functional part located in a portion caused to protrude towards a recording medium, and the recording medium can be kept short, and the floating distance can be stabilized by the local positive pressure parts located on both sides of the protruding part.

In one embodiment, a magnetic head device with low floating height in which the floating height of the magnetic functional part is reduced can be realized, and even when a tilt angle is formed and the tilt angle changes, it is possible to always stabilize the distance between the trailing end face of the slider and the recording medium.

In one embodiment, when a magnetic head device that has a structure where a portion having a magnetic functional part is caused to protrude towards a recording medium by providing a heater or the like is adopted, a large positive pressure may be prevented from acting on the portion, which protrudes towards the recording medium, and it becomes easy to maintain a state where the magnetic functional part is caused to approach the recording medium.

### DRAWING

FIG. 1 is a plan view when a magnetic head device of one embodiment viewed from the facing side;

FIG. 2 is a plan view showing a first embodiment of a rear positive pressure surface when a slider is located in (MD);

FIG. 3 is a plan view that shows one embodiment of the rear positive pressure surface when the slider is located in (ID);

FIG. 4 is a plan view that shows one embodiment of the rear positive pressure surface when the slider is located in (OD);

FIG. 5 is an enlarged plan view that shows a second embodiment of a rear positive pressure surface of a magnetic head device;

FIG. 6 is a side view of one embodiment of a supporter which supports a magnetic head device;

FIG. 7 is a plan view that shows the opposed positions between a recording medium and a magnetic head;

FIG. 8 is a plan view that shows one embodiment of a rear positive pressure surface when a slider is located in (MD) in a magnetic head of a comparative example;

FIG. 9 is a plan view that shows one embodiment of the rear positive pressure surface when the slider is located in (ID), in the magnetic head of the comparative example; and

FIG. 10 is a plan view that shows one embodiment of the rear positive pressure surface when the slider is located in (OD) in the magnetic head of the comparative example.

### DETAILED DESCRIPTION

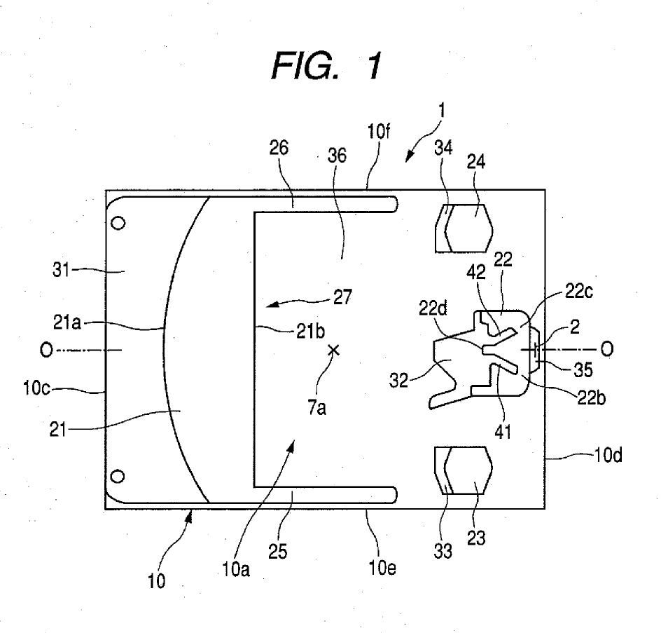

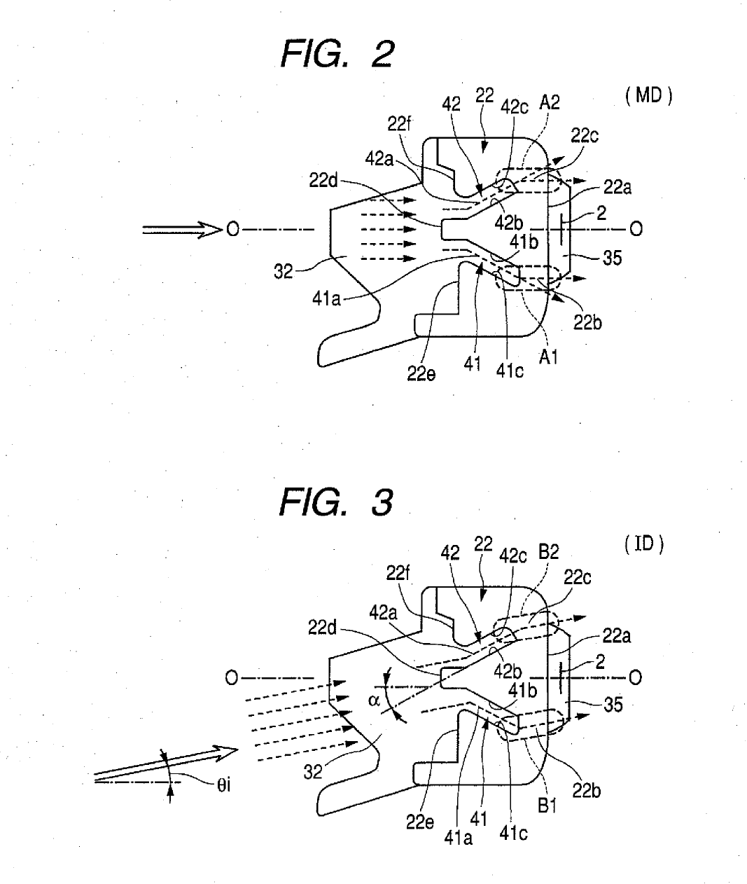

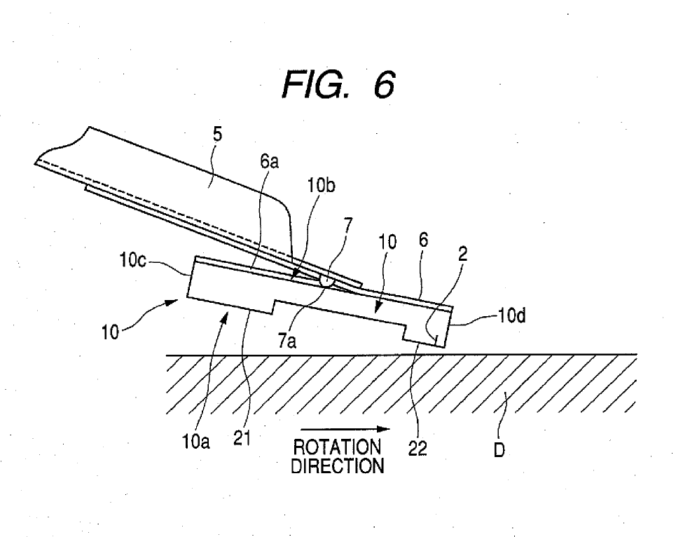

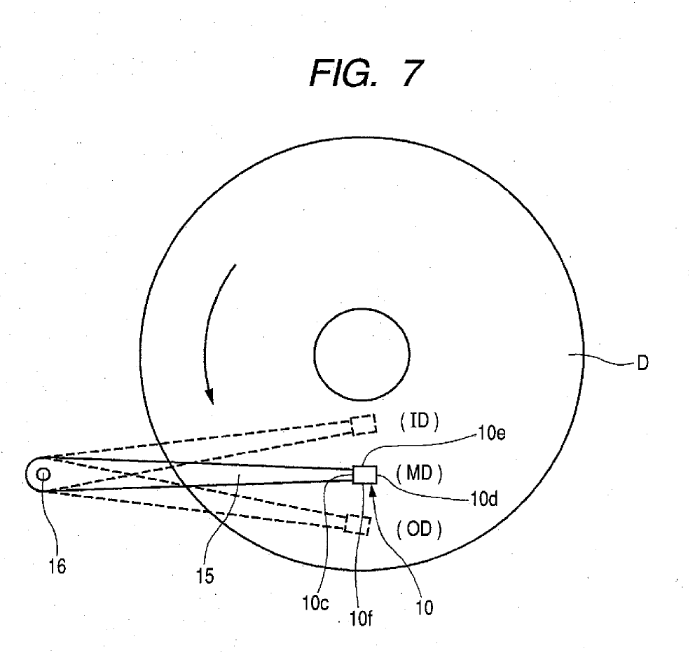

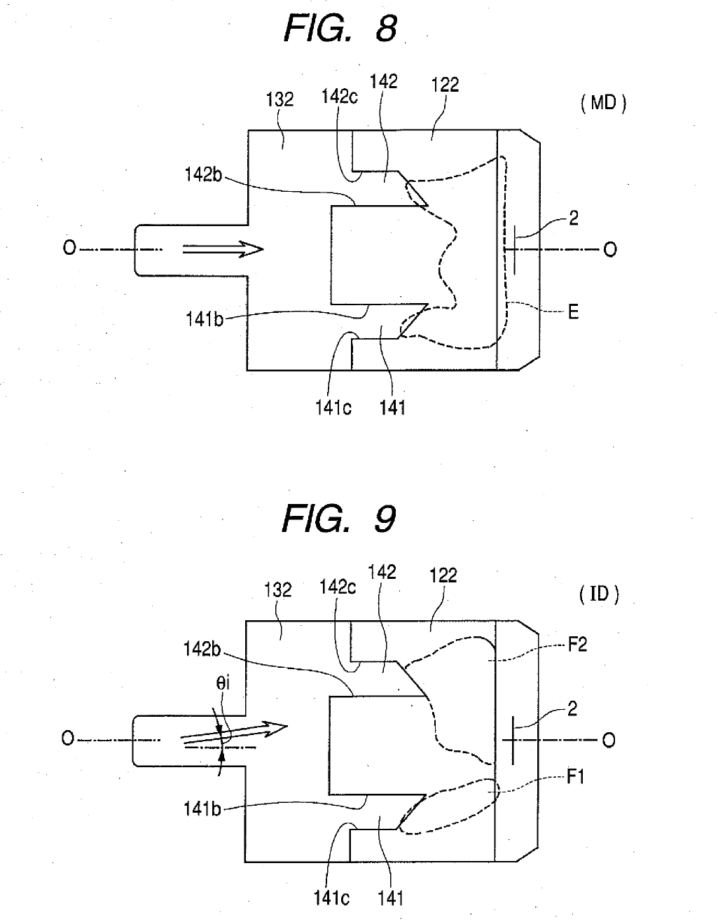

FIG. 1 is a plan view when a magnetic head device of a first embodiment of the invention is viewed from the facing side facing a recording medium. FIGS. 2, 3, and 4 are enlarged explanatory views illustrating the generation state of the local positive pressure in a rear positive pressure surface provided on the facing side of a slider of the magnetic head device on the basis of simulation. FIG. 5 is an enlarged plan view of a rear positive pressure surface of a slider in a magnetic head device of a second embodiment of the invention. FIG. 6 is a side view that shows a supporter with supports the magnetic head device, and FIG. 7 is a plan view that shows the opposed state of a recording medium and the magnetic head device. FIG. 8 to FIG. 10 are explanatory views illustrating the generation state of the positive pressure in a rear positive pressure surface of a magnetic head device of a comparative example on the basis of simulation.

In one embodiment, as shown in FIG. 1, the magnetic head device 1 has a cubical slider 10 formed of alumina/titanium carbide, or the like and has a magnetic functional part 2 carried at a trailing end of the slider 10.

The magnetic functional part 2 has a reading functional part which reads magnetic signals recorded on a recording medium D utilizing a magnetoresistive effect (MR effect), a giant magnetoresistive effect (GMR effect), or a tunnel magnetoresistive effect (TMR effect), and a recording functional part which is formed with a yoke made of a magnetic material or a coil made of a conductive material in a thin film process and writes magnetic signals in the recording medium D, utilizing the above effect.

In one embodiment, as shown in FIG. 6, the slider 10 has a facing side 10a which faces a recording medium, and a pressing side 10b which faces the opposite side of the facing side 10a. FIG. 1 shows the facing side 10a of the slider 10. The slider 10 has a leading end face 10c which faces the inflow side of the airflow generated on the surface of the recording medium D, and a trailing end face 10d from which the airflow flows out, and the magnetic functional part 2 is provided on the trailing end face 10d.

The slider 10 has an inner peripheral side face 10e facing the rotation center side of the disc-like recording medium D based on a magnetic recording system, such as a hard disk shown in FIG. 7, and an outer peripheral side face 10f facing an outer periphery of the recording medium D.

A direction which faces the leading end face 10c may be referred to as the front, an end which faces the leading end face 10c may be referred to as a front end, a direction which faces the trailing end face 10d may be referred to as the rear, an end which faces the trailing end face 10d may be referred to as a rear end. A direction parallel to the leading end face 10c and trailing end face 10d may be referred to as a right and left direction, and on the basis of FIG. 1, the side which faces the inner peripheral side face 10e may be referred to as the left, and the side which faces the outer peripheral side faces 10f may be referred to as the right.

In FIG. 1, an imaginary line which extends in a front-and-back direction while bisecting the leading end face 10c and the trailing end face 10d is used as a centerline O-O. The center of the magnetic functional part 2 is located on this centerline O-O. Therefore, in this embodiment, the centerline O-O is a reference line.

In one embodiment, as shown in FIG. 6, the pressing side 10b of the slider 10, which constitutes the magnetic head device 1 is supported by a supporter. This supporter is provided with a load beam 5 that is an elastic supporting member. A base of this load beam 5 is provided with an elastic deformation part, and a pressing force is applied to the slider 10 in the direction of the recording medium D by the elastic force of this elastic deformation part. A flexure 6 formed of an elastic plate which is thinner than the load beam 5 and exhibits a spring property is fixed to a tip of the load beam 5, and the surface of the pressing side 10b of the slider 10 is fixedly adhered to a supporting piece 6a formed by bending a part of this flexure 6.

A downwardly projecting pivot 7 is integrally formed at the tip of the load beam 5, and this pivot 7 abuts on the surface of the pressing side 10b of the slider 10, or abuts on the supporting piece 6a. The elastic pressing force exhibited by the load beam 5 acts on an abutment point 7a of the pivot 7 in a concentrated manner and the surface of the pressing side 10b of the slider 10. The supporting piece 6a of the flexure 6 can be deformed in all directions, and the slider 10 fixed to the supporting piece 6a can be changed in posture by using the point 7a abutting on the pivot 7 as a fulcrum. The principal directions of the posture change are a pitching direction in which the centerline O-O inclines and a rolling direction in which the slider inclines to the right and left around the centerline O-O. In the floating posture in which the leading end face 10c is raised as shown in FIG. 6, the angle which is formed between the slider and the surface of the recording medium D is a pitching angle.

The abutment point 7a between the pivot 7 and the slider 10 is shown in FIG. 1 as being projected. This abutment point 7a is located on the centerline O-O, and is located almost in a midpoint between the leading end face 10c and the trailing end face 10d.

In one embodiment, as shown in FIG. 1, a positive pressure surface formed in a position nearest to the recording medium D is provided on the facing side 10a of the slider 10. This positive pressure surface is composed of a front positive pressure surface 21 which is located nearer to the leading side than the abutment point 7a, a rear positive pressure surface 22 which is located nearer to the trailing side than the abutment point 7a and provided in a position close to the trailing end face 10d, and lateral positive pressure surfaces 23 and 24 which are located nearer to the trailing side than the abutment point 7a, and located nearer to the leading side than the rear positive pressure surface 22.

The front positive pressure surface 21, the rear positive pressure surface 22, and the lateral positive pressure surfaces 23 and 24 are located on the same plane, and has the same projection heights in the direction of the recording medium D. However, the front positive pressure surface 21, the rear positive pressure surface 22, and the lateral positive pressure surfaces 23 and 24 may be different in their projection heights in the direction of the recording medium D.

The rear positive pressure surface 22 has a smaller area than the front positive pressure surface 21. Moreover, the center of the width of the front positive pressure surface 21 in the right and left direction and the center of the width of the rear positive pressure surface 22 in the right and left direction are located on the centerline O-O. The lateral positive pressure surface 23 is formed in a position close to the inner peripheral side face 10e, the lateral positive pressure surface 24 is formed in a position close to the outer peripheral side face 10f, and the lateral positive pressure surface 23 and the lateral positive pressure surface 24 are located in positions the same distance away from the centerline O-O toward the right and left with the centerline O-O therebetween. The area of each of the lateral positive pressure surfaces 23 and 24 is smaller than the area of the rear positive pressure surface 22.

A step face, which is formed one step lower away from the recording medium D than the positive pressure surfaces, is provided on the facing side 10a of the slider 10. This step face is composed of a front step face 31 which is formed between a front end 21a of the front positive pressure surface 21 and the leading end face 10c, a rear step face 32 which extends forward from a front end of the rear positive pressure surface 22, a lateral step face 33 which extends forward from a front end of the lateral positive pressure surface 23, and a lateral step face 34 which extends forward from a front end of the lateral positive pressure surface 24.

The front step face 31, the rear step face 32, and the lateral step face 33, and the lateral step face 34 are located on the same plane and have the same projection in the direction which faces the recording medium D. However, the step faces may have different projection heights towards the recording medium D.

On the facing side 10a of the slider 10, a region excluding the positive pressure surfaces and the step faces is a lowermost bottom face 36. This lowermost bottom face 36 is formed in a position where it retreats to the side further away from the recording medium D than the step faces.

The front step face 31 exhibits a function to lead airflow (air bearing), which flows into the facing side 10a from the leading end face 10c, to the surface of the front positive pressure surface 21. The rear step face 32 exhibits a function to lead airflow, which runs to the trailing end face 10d, to the surface of the rear positive pressure surface 22. Similarly, both the lateral step faces 33 and 34 exhibit a function to lead airflow to the surface of the lateral positive pressure surfaces 23 and 24.

In one embodiment, the height difference between each of the positive pressure surfaces and each of the step faces is about 0.3 μm or less, for example, and the lower limit of the height difference is about 0.05 μm.

The lowermost bottom face 36 is required to be distant from the positive pressure surfaces so that positive pressure may not be substantially generated by the air of the facing side 10a. For this purpose, it is preferable that the height difference between each of the positive pressure surfaces and the lowermost bottom face 36 be 1 μm or more and 5 μm or less.

Extending portions 25 and 26 which integrally extend rearward from right and left side parts of the front positive pressure surface 21 are formed on the facing side 10a of the slider 10, and the lowermost bottom face 36 is located in a portion surrounded by both the extending portions 26 and 26 and a rear end 21b of the front positive pressure surface 21. The extending portion 25 extends rearward along the side face 10e continuously with the rear end 21b of the front positive pressure surface 21, and the extending portion 26 extends rearward along the side face 10f from the rear end 21b of the front positive pressure surface 21. The surfaces of the extending portions 25 and 26 are continuous with the front positive pressure surface 21. As a result, a negative pressure generating region 27 where negative pressure is generated by airflow which flows through the facing side 10a is formed behind the front positive pressure surface 21. By the positive pressure which acts on the front positive pressure surface 21, and the negative pressure of the negative pressure generating region 27, the floating distance of the slider 10 from the recording medium is adjusted, and the inclined posture of the slider 10 is also adjusted.

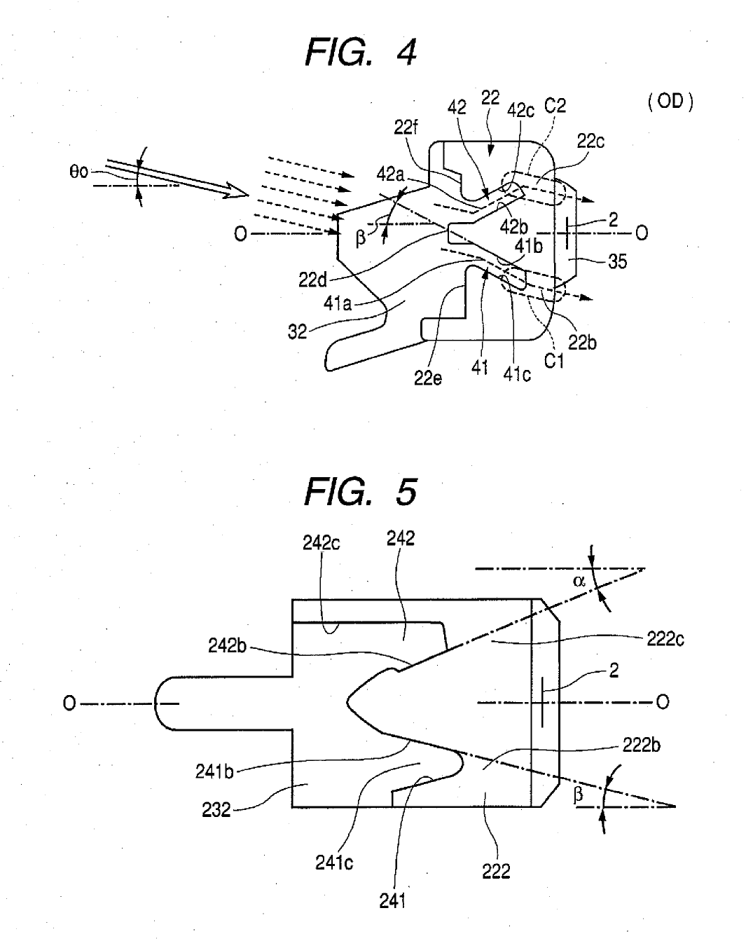

As shown in FIGS. 2 and 4 in one embodiment, a recessed face 35 formed in a position slightly away from the recording medium than the rear positive pressure surface 22 is provided further behind than the rear positive pressure surface 22, and the magnetic functional part 2 is located on this recessed face 35. For example, the magnetic functional part 2 is provided in a position close to a rear end 22a of the rear positive pressure surface 22. In addition, the magnetic functional part 2 may be provided inside the rear positive pressure surface 22.

In one embodiment, on the rear positive pressure surface 22, a first air guide groove 41 is formed on the left side of the centerline O-O, and a second air guide groove 42 is formed on the right side of the centerline O-O. A bottom face 41a of the first air guide groove 41 and a bottom face 42a of the second air guide groove 42 are faces which are continuous with the rear step face 32.

As shown in FIGS. 2 to 4, in the first air guide groove 41, an inside inner wall 41b that is a groove inner wall near to the centerline O-O is formed along an inclination line. This inclination line is a straight line, and inclines such that it is gradually away from the centerline O-O, as it goes to the trailing end face 10d. In the second air guide groove 42, an inside inner wall 42b that is a groove inner wall near to the centerline O-O is formed along an inclination line. This inclination line is also a straight line, and inclines such that it is gradually away from the centerline O-O, as it goes to the trailing end face 10d. In addition, the inside inner wall 41b and the inside inner wall 42b may be formed along an inclination line formed by a curved locus such that it is gradually away from the centerline O-O, as it goes to the trailing end face 10d.

In one embodiment, in the first air guide groove 41, an outside inner wall 41c, which faces the inside inner wall 41b, inclines in the same direction as the inside inner wall 41b, and in the second air guide groove 42, an outside inner wall 42c which faces the inside inner wall 42b is formed in the same direction as the inside inner wall 42b. Therefore, both a groove centerline which bisects the inner width of the first air guide groove 41, and the groove centerline which bisects the inner width of a second air guide groove 42 incline such that they are gradually away from the centerline O-O, as they go to the trailing end face 10d.

In one embodiment, the first air guide groove 41 can centralize airflow on a part of the rear positive pressure surface 22, and a part of the rear positive pressure surface 22 located behind the first air guide groove 41 becomes a local positive pressure generating part 22b. Similarly, the second air guide groove 42 can centralize airflow on a part of the rear positive pressure surface 22, and a part of the rear positive pressure surface 22 located behind the second air guide groove 42 becomes a local positive pressure generating part 22c.

In one embodiment, in the rear positive pressure 22, a forward protruding part 22d which protrudes forward along the centerline O-O is formed. This forward protruding part 22d protrudes further forward than lateral front ends 22e and 22f of the rear positive pressure surface 22 located on the right and left sides thereof. A rear face 32 is formed such that the airflow which runs to the trailing side is branched into right and left airflows in the right and left protruding part 22d, and thereby the airflow dividedly flows into the first air guide groove 41 and the second air guide groove 42.

In one embodiment, as shown in FIG. 7, in the supporter, which supports the magnetic head device 1, a base of an arm 15 to which the load beam 5 is fixed is rotatably supported by a shaft 16, and the arm 15 is rotated by an actuator based on an electromagnetic drive system which is not shown. As a result, the arm 10 moves along an arc locus centering on the shaft 16 from the inner peripheral side of the recording medium D to the outer peripheral side thereof.

In FIG. 7, (ID) represents a position where the slider 10 has moved to the inner peripheral side of the recording medium D, and has reached a termination of the moving range thereof, and (OD) represents a position where the slider has reached a termination of the moving range on the outer peripheral side of the recording medium. Moreover, (MD) represents a position where the centerline O-O of the slider coincides with a tangential line of a circumference on the recording medium in the position.

When the slider 10 has reached the position (ID), a tilt angle θi is formed between a tangential line of a circumference on the recording medium in the position and the centerline O-O of the slider 10, and when the slider 10 has reached the position (OD), a tilt angle θo is formed between a tangential line of a circumference on the recording medium in the position and the centerline O-O of the slider 10.

In one embodiment, as shown in FIG. 3, an internal angle α, which is formed by the inside inner wall 42b of the second air guide groove 42, and the centerline O-O is greater than a tilt angle β when the slider 10 is located in (ID). Moreover, as shown in FIG. 4, an internal angle β which is formed by the inside inner wall 41b of the first air guide groove 41, and the centerline O-O is greater than a tilt angle βo when the slider 10 is located in (OD).

Therefore, as shown in FIG. 3, when the slider 10 is located in (ID), the airflow which flows at the tilt angle θi with respect to the centerline O-O can be surely led into the second air guide groove 42. Since the first guide groove 41 is opened towards the upstream of the airflow, the airflow can be surely led into the first air guide groove 41.

In one embodiment, as shown in FIG. 4, when the slider 10 is located in (OD), the airflow which flows at the tilt angle θo with respect to the centerline O-O can be surely led into the first air guide groove 41. Since the second air guide groove 42 is opened towards the upstream of the airflow, the airflow can also be led into the second air guide groove 42.

In one embodiment, as shown in FIG. 2, when the slider 10 is located in (MD), the airflow which flows almost parallel to the centerline O-O towards the trailing end face 10d above the intermediate central step face 32 is divided and flows into the first air guide groove 41 and the second air guide groove 42. The first air guide groove 41 and the second air guide groove 42 incline such that they are away from each other, as they go to the trailing side. Therefore, the airflow which has proceeded into the first air guide groove 41, and the airflow which has proceeded into the second air guide groove 42 advance while they are away from each other as it goes to the trailing side, and are collected and moved to the surfaces of the local positive pressure generating part 22b and local positive pressure generating part 22c, which are located behind the grooves. Therefore, in the rear positive pressure surface 22, the local positive pressure generating part 22b becomes a comparatively large positive pressure generating region A1, and the local positive pressure generating part 22c becomes a comparatively large positive pressure generating region A2. Moreover, it becomes easy to separate the positive pressure generating region A1 and the positive pressure generating region A2 in the right and left direction.

In one embodiment, as shown in FIG. 3, even when the slider 10 is located in (ID), as described above, the airflow which moves above the surface of the intermediate central step face 32 at the tilt angle θI are divided and flow into the first air guide groove 41 and the second air guide groove 42. Thus, in the rear positive pressure surface 22, the local positive pressure generating part 22b becomes a comparatively large positive pressure generating region B1, and the local positive pressure generating part 22c becomes a comparatively large positive pressure generation region B2.

In one embodiment, as shown in FIG. 4, even when the slider 10 is located in (OD), the local positive pressure generating part 22b becomes a comparatively large positive pressure generating region C1, and the local positive pressure generating part 22c becomes a comparatively large positive pressure generating region C2.

In one embodiment, in the vicinity of the centerline O-O of the rear positive pressure surface 22, positive pressure is not generated, or even if positive pressure is generated, the floating pressure which acts on the vicinity of the centerline O-O of the rear positive pressure surface 22 by this positive pressure becomes a value which is sufficiently smaller than the floating pressure which acts on the local positive pressure generating part 22b and the local positive pressure generating part 22c.

As shown in FIGS. 6 and 7, when the recording medium D rotates in the direction indicated by the arrow of FIG. 7 in a state where the slider 10 of the magnetic head device 1 faces the recording medium D, the airflow (air bearing) runs to the trailing side from the leading side of the slider 10 between the surface of the recording medium D, and the facing side 10a of the slider 10. This airflow flows into the surface of the front positive pressure surface 21 from the front step face 31, whereby positive pressure and the resulting floating force act on the front positive pressure surface 21, thereby raising the leading end face 10c immediately after the recording medium D starts.

In one embodiment, as the airflow passes towards the trailing side from the leading side between the facing side 10a of the slider 10, and the recording medium D, the slider 10 floats from the surface of the recording medium D. Since the area of the front positive pressure surface 21 is greater than the area of the rear positive pressure surface 22, a large positive pressure acts on a front portion of the slider 10, and since the slider 10 takes a posture fanned by the airflow, the slider 10, as shown in FIG. 6, takes a floating posture which has a predetermined pitching angle such that the leading end face 10c is further away from the recording medium D than trailing end face 10d.

In one embodiment, the floating distance of the magnetic functional part 2, which is provided at the trailing end of the slider 10, from the rear face of the recording medium D is greatly influenced by in the floating force which acts on the rear positive pressure surface 22.

In the magnetic head device, as shown in FIGS. 2 to 4, positive pressure locally acts on the local positive pressure generating parts 22b and 22c of the rear positive pressure surface 22 in a concentrated manner. Even in a case where the slider 10 is set to have a tilt angle between (ID) and (OD), the positive pressure continues to locally act on the local positive pressure generating parts 22b and 22c in a concentrated manner. Since the positive pressure locally concentrated on the rear positive pressure surface 22 can always be caused to act, even if the slider 10 is in any position on the recording medium D, it is possible to stabilize the floating distance of the magnetic functional part 2 from the recording medium D.

Moreover, in the magnetic head device of the present embodiment, the lateral positive pressure surfaces 23 and 24 are provided in the positions separated to the right and left from the centerline O-O. Thus, the rotating posture of the slider 10 in the rolling direction can be stabilized by the positive pressure which acts on these lateral positive pressure surfaces 23 and 24.

FIGS. 8 to 10 show a part of a facing side of a slider in a magnetic head device of a comparative example. In the magnetic head device of the comparative example, a rear positive pressure surface 122 is formed behind a rear step face 132, and air guide grooves 141 and 142 are formed in right and left positions of the rear positive pressure surface 122 with centerline O-O therebetween. However, inside inner walls 141b and 142b of the air guide grooves 141 and 142 are parallel to the centerline O-O, and outside inner walls 141c and 142c of the air guide grooves 141 and 142 are also parallel to the centerline O-O.

As shown in FIG. 8, when the slider is located in (MD), the airflow, which flows on the surface of the step face 132, is divided and flow into the air guide grooves 141 and 142. Since both the air guide grooves 141 and 142 are formed parallel to the centerline O-O, when the airflow which has proceeded into the air guide grooves 141 and 142 has reached the rear positive pressure surface 122 behind the air guide grooves, the air flows in a comparatively broad range of the rear positive pressure surface 122, and consequently a comparatively broad range of the rear positive pressure surface 122 becomes a positive pressure generating region E. Therefore, positive pressure cannot be locally centralized to the rear of the air guide grooves like the embodiment of the invention.

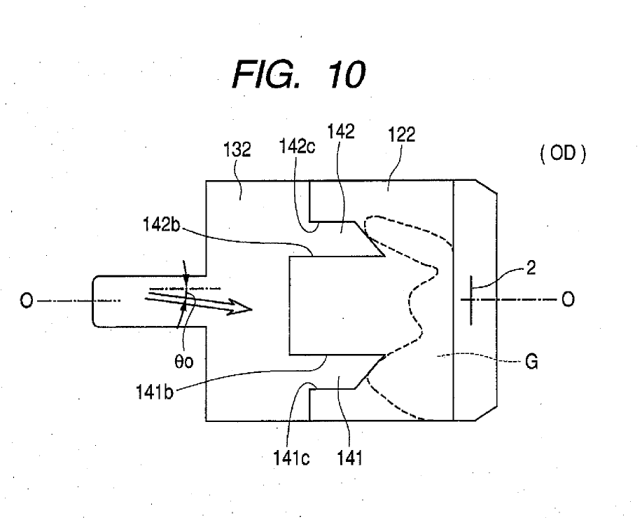

In one embodiment, as shown in FIG. 9, when the slider is located in (ID), it is difficult that the airflow which flows at a tilt angle θi flows into the second air guide groove 142, and it becomes easy that the airflow flows to the surface of the rear positive pressure surface 122 on the centerline O-O. Therefore, positive pressure generating regions F1 and F2 are formed in a broad range of the rear positive pressure surface 122. Even when the slider is located in (OD), as shown in FIG. 10, the air, which flows at a tilt angle θo, does not easily enter the first air guide groove 141 and the airflow easily proceeds to the surface on the centerline O-O of the rear positive pressure surface 122. The positive pressure generating region G is decentralized over a comparatively broad range of the rear positive pressure surface 122.

In addition, simulation of the magnetic head device 1 of the first embodiment, and simulation of the magnetic head device of the comparative example are based on computer analysis. Specifically, in both the simulations of the present embodiment and the comparative example, the long side of a slider was 1.24 mm, the short side of the slider is set to about 1.00 mm, the height difference between a step face and a positive pressure surface is set to about 0.15 μm, and the height difference between a lowermost bottom face and a positive pressure surface is set to 2 μm. Moreover, the analysis was performed under the conditions that the pressing force (load pressure) in the direction of the recording medium D by a load beam is set to about 24.5 mN, and the number of revolutions of the recording medium D is set to about 7200 rpm.

FIG. 5 shows a part of a facing side of a slider in a magnetic head device of a second embodiment of the invention in an enlarged manner.

In one embodiment, a first air guide groove 241 and a second air guide groove 242 are provided in a rear positive pressure surface 222. The preferable range of an internal angle α which is formed between an inside inner wall 241b of the first air guide groove 241 and a centerline O-O, and the preferable range of an internal angle β which is formed between an inside inner wall 242b of the second air guide groove 242 and the centerline O-O are the same as those of the first embodiment.

In the embodiment shown in FIG. 5, an outside inner wall 241c of the first air guide groove 241 inclines such that it is gradually away from the centerline O-O, as it goes to a leading end face, and an outside inner wall 242c of the second air guide groove 242 is parallel to the centerline O-O.

Even in this embodiment, a local positive pressure generating part 222b may be formed in a portion further behind than the first air guide groove 241 of the rear positive pressure surfaces 222, and a local positive pressure generating part 222c can be formed in a portion further behind than the second air guide groove 242.

As described above, positive pressure can be locally centralized on positions separated by the same distance to the right and left from the centerline O-O in the rear positive pressure surface, and local centralization of positive pressure does not change even by the tilt angle and its changes. Therefore, even if the slider is in any position on the recording medium D, it is possible to stabilize the floating force which acts on the rear positive pressure surface, and to always stabilize the floating distance between the magnetic functional part 2 and the recording medium D.

In a magnetic head device in which the vicinity of a centerline O-O in a rear positive pressure surface and its neighborhood is caused to protrude a recording medium, and thereby the magnetic functional part 2 can be caused to approach the recording medium D, great positive pressure does not act on a portion which protrudes towards the recording medium, but positive pressure locally acts on the right and left sides of the protruding part in a concentrated manner. Therefore, the force away from the recording medium D does not act on the protruding part, and, moreover, the floating distance between the magnetic functional part 2 and the recording medium D is stabilized.

Even in a magnetic head device in which a heater, which heats the magnetic functional part 2, is carried on the slider 10, and the slider expands and deforms by the heat of the heater to cause the magnetic functional part 2 to approach the recording medium D, a great floating force can be prevented from acting on a portion (mainly a portion on the centerline O-O) which protrudes towards the recording medium by the expansion and deformation, and the floating distance of the magnetic functional part 2 from the recording medium can be stabilized by the positive pressure locally concentrated on the both sides of the protruding part.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A magnetic head device comprising:
a slider that has a facing side, which faces a recording medium, and a pressing side on which a pressing force to a recording medium acts, and
a magnetic device provided on the trailing side of the slider to exhibit at least one function of magnetic recording and magnetic reproducing,
wherein the facing side of the slider is provided with a front positive pressure surface located on the leading side of the slider and a rear positive pressure surface located on the trailing side of the slider, and the magnetic device is provided in the vicinity behind the rear positive pressure surface,
wherein air guide grooves are respectively formed on both sides of the rear positive pressure surface with respect to a reference line that is a virtual straight line which extends from the leading side to the trailing side through the center of the magnetic device, and a part of the rear positive pressure surface exists further behind than the air guide grooves.

2. The magnetic head device according to claim 1, wherein each of the air guide grooves is inclined such that an inside inner wall thereof on the side of the reference line is gradually away from the reference line as it goes to the trailing side.

3. The magnetic head device according to claim 2,
wherein an outside inner wall which faces the inside inner wall of each air guide groove inclines in the same direction as the inside inner wall.

4. The magnetic head device according to claim 2,
wherein an outside inner wall, which faces the inside inner wall of each air guide groove, extends parallel to the reference line.

5. The magnetic head device according to claim 4,
wherein an internal angle between the reference line and the inside inner wall is greater than a maximum value of a tilt angle when the slider moves on the recording medium.

6. The magnetic head device according to claim 1,
wherein the rear positive pressure surface is formed such that its central portion located on the reference line protrudes or is allowed to protrude nearer to the recording medium than its side parts located further behind than a rear end of the air guide groove.

7. The magnetic head device according to claim 5,
wherein the slider is provided with a heater which heats the magnetic device, and the central portion is allowed to protrude by the heat of the heater.

8. The magnetic head device according to claim 1, wherein the magnetic device is operative to perform magnetic recording or magnetic reproducing.

9. The magnetic head device according to claim 1, wherein each of the air guide grooves is inclined linearly or curvedly.

10. A magnetic head device comprising:
a slider that has a facing side which faces a recording medium, and a pressing side on which a pressing force to a recording medium acts, and
a magnetic device provided on the trailing side of the slider,
wherein the facing side of the slider is provided with a front positive pressure surface located on the leading side of the slider and a rear positive pressure surface located on the trailing side of the slider, and the magnetic device is provided in the rear positive pressure surface,
wherein air guide grooves are respectively formed on both sides of the rear positive pressure surface with respect to a reference line that is a virtual straight line which extends from the leading side to the trailing side through the center of the magnetic device, and a part of the rear positive pressure surface exists further behind than the air guide grooves, and
wherein each of the air guide grooves are inclined.

11. The magnetic head device according to claim 10, wherein each of the air guide grooves are inclined linearly or curvedly such that an inside inner wall thereof on the side of the reference line is gradually away from the reference line as it goes to the trailing side.

12. The magnetic head device according to claim 11,
wherein an outside inner wall, which faces the inside inner wall of each air guide groove, inclines in the same direction as the inside inner wall.

13. The magnetic head device according to claim 1,
wherein an outside inner wall, which faces the inside inner wall of each air guide groove, extends parallel to the reference line.

14. The magnetic head device according to claim 13,
wherein an internal angle between the reference line and the inside inner wall is greater than a maximum value of a tilt angle when the slider moves on the recording medium.

15. The magnetic head device according to claim 10,
wherein the rear positive pressure surface is formed such that its central portion located on the reference line protrudes or is allowed to protrude nearer to the recording medium than its side parts located further behind than a rear end of the air guide groove.

16. The magnetic head device according to claim 15,
wherein the slider is provided with a heater which heats the magnetic device, and the central portion is allowed to protrude by the heat of the heater.

17. The magnetic head device according to claim 10, wherein the magnetic device is operative to perform magnetic recording or magnetic reproducing.
